(19) United States
(12) Patent Application Publication
(10) Pub. No.: US 2021/0244617 A1
(43) Pub. Date: Aug. 12, 2021

(54) CAPSULE CLOSURE DEVICE FOR CLOSING TWO-PIECE CAPSULES

(71) Applicant: Harro Hoefliger Verpackungsmaschinen GmbH, Allmersbach im Tal (DE)

(72) Inventors: Marco Weigel, Allmersbach im Tal (DE); Steffen Gall, Allmersbach im Tal (DE)

(21) Appl. No.: 17/168,839

(22) Filed: Feb. 5, 2021

(30) Foreign Application Priority Data
Feb. 7, 2020 (EP) 20 156 171.9

(51) Int. Cl. A61J 3/07

(52) U.S. Cl. CPC A61J 3/074

(57) ABSTRACT

The disclosure relates to a capsule closure device for closing two-piece capsules each having a capsule upper portion and a capsule lower portion. The capsule closure device includes a capsule upper portion receiving member and a capsule lower portion receiving member. The capsule upper portion receiving member has a receiving hole and an introduction hole which is arranged coaxially relative to the receiving hole. The capsule upper portion receiving member has at the inner side thereof between the receiving hole and the introduction hole a support shoulder for supporting the capsule upper portion. The capsule upper portion receiving member has at the inner side thereof a ventilation groove, wherein the ventilation groove extends from the receiving hole to the introduction hole.

### CROSS REFERENCE TO RELATED APPLICATION

This application claims priority of European patent application no. 20 156 171.9, filed Feb. 7, 2020, the entire content of which is incorporated herein by reference.

### FIELD OF THE INVENTION

The disclosure relates to a capsule closure device for closing two-piece capsules.

### BACKGROUND OF THE INVENTION

In particular in the pharmaceutical field, but also in the field of food supplements, or the like, easy-to-swallow capsules are used, the inner space of which is filled with active ingredient preparations or the like. Such capsules are constructed in two pieces and include a capsule lower portion and a capsule upper portion which is placed thereon. Widely used capsule materials are hard gelatin, HPMC (hydroxypropyl methylcellulose) or the like.

Empty capsules are supplied for filling in the loosely assembled state and supplied to a capsule closure device. This includes a capsule upper portion receiving member and a capsule lower portion receiving member, wherein the loosely assembled empty capsule first comes to rest in the capsule upper portion receiving member. From here, the capsule lower portion is removed from the capsule upper portion, for example, by means of reduced pressure, and introduced into the capsule lower portion receiving member. The filling of the capsule lower portion takes place in the capsule lower portion receiving member. Subsequently, the capsule lower portion is pressed, for example, by means of a stamp, relative to the capsule upper portion receiving member and introduced there into the capsule upper portion.

During practical operation of such a capsule closure device, during the opening of the capsule high separation forces are required. Such separation forces are formed by means of a reduced pressure acting on the capsule lower portion. If the capsule lower portion has become released from the capsule upper portion, the capsule lower portion is conveyed by the high reduced pressure applied in such a rapid manner into the capsule lower portion receiving member that a so-called capsule jump can take place. The capsule jump occurs when the capsule lower portion strikes the capsule lower portion receiving member in an uncentered manner and a reverse pulse expels the capsule lower portion out of the capsule lower portion receiving member. Such a capsule jump can also occur in the case of capsule upper portions, such that the capsule upper portion jumps out of the capsule upper portion receiving member after the capsule lower portion has been separated from the capsule upper portion.

Furthermore, with such high separation forces, the capsule base of the capsule lower portion can also tear or break when striking the capsule lower portion receiving member. Since, when the capsule is closed, high forces are also required, as a result of the stamp engaging on the base of the capsule lower portion, the base can be pressed in or even break.

### SUMMARY OF THE INVENTION

It is an object of the invention is to provide a capsule closure device in such a manner that the operational reliability thereof is increased.

This object can, for example, be achieved by a capsule closure device for closing two-piece capsules each having a capsule upper portion and a capsule lower portion. The capsule closure device includes: a capsule upper portion receiving member and a capsule lower portion receiving member; the capsule upper portion receiving member defining a receiving hole and an introduction hole which is arranged coaxially relative to the receiving hole; the capsule upper portion receiving member having an inner side; the capsule upper portion receiving member having a support shoulder for supporting the capsule upper portion at the inner side, wherein the support shoulder is disposed between the receiving hole and the introduction hole; and, the capsule upper portion receiving member defining at the inner side at least one ventilation groove, wherein the ventilation groove extends from the receiving hole to the introduction hole.

The capsule closure device according to the disclosure is based on the consideration that the required high forces for separating and closing the capsule are based on a lack of pressure compensation. When the capsule is separated, the capsule upper portion is supported along the capsule edge thereof on the support shoulder of the capsule upper portion receiving member. The capsule lower portion is in flush abutment with the introduction hole of the capsule upper portion receiving member.

Consequently, the capsule upper portion and the capsule lower portion delimit an inner space whose volume expands with the downward movement of the capsule lower portion in the direction of the capsule lower portion receiving member. In this instance, the inner space remains at least initially substantially closed in an airtight manner. Accordingly, in the inner space between the capsule upper portion and capsule lower portion, there is formed a reduced pressure which makes separation of the capsule more difficult. After a correspondingly long downward movement of the capsule lower portion, the capsule lower portion leaves the capsule upper portion receiving member, whereby the inner space formed by the capsule upper portion and capsule lower portion opens. This is followed by a pressure compensation which, on account of the previously produced high reduced pressure, brings about a changing pulse which is of such a magnitude that the capsule upper portion may be pushed out of the capsule upper portion receiving member.

In order to reduce the high separation forces and the high changing pulse, the capsule upper portion receiving member has at the inner side thereof at least one ventilation groove. The ventilation groove extends from the receiving hole to the introduction hole. Preferably, the capsule upper portion receiving member has at the inner side thereof at least two, in particular three ventilation grooves. Through the ventilation groove, when the capsule is opened, sufficient air can flow into the inner space between the capsule upper portion and capsule lower portion so that a pressure compensation is ensured. No or at most only a small reduced pressure is produced in the inner space. As the number of ventilation grooves in the capsule upper portion receiving member increases, the pressure compensation can be carried out more rapidly. The capsule lower portion can be more readily separated from the capsule upper portion. As a result of the reduced separation forces, the capsule lower portion which is ultimately released is drawn into the capsule lower portion receiving member with less impact, whereby a capsule jump or other damage to the capsule can be prevented. As a result of the avoidance of a high reduced pressure, the resulting changing pulse in the case of a pressure compensation is also only very low, such that undesired expelling of the capsule upper portion out of the capsule upper portion receiving member can be avoided.

The pressure compensation is also carried out when the capsule is closed. When the capsule lower portion is pushed through the capsule upper portion receiving member into the capsule upper portion, the volume of the inner space between the capsule lower portion and the capsule upper portion is reduced. The excess air escapes through the ventilation groove, whereby excess pressure when the capsule is closed can be prevented. Accordingly, no excess pressure counteracts the closure force on the capsule lower portion. The forces can thereby be reduced when the capsule is closed so that any damage to the capsule as a result of excessively high closure forces can be prevented.

Preferably, the receiving hole of the capsule upper portion extends from a first longitudinal end as far as a second longitudinal end at the support shoulder, wherein the at least one ventilation groove extends from the introduction hole as far as the first longitudinal end of the receiving hole. The first longitudinal end of the receiving hole corresponds to an introduction region having a lead-in chamfer for introduction of the capsule. When the capsule is opened, the air can thereby flow into the capsule upper portion receiving member or, when the capsule is closed, escape from the capsule upper portion receiving member. A pressure compensation with the environment is thereby ensured in the capsule upper portion receiving member in particular in the inner space between the capsule upper portion and the capsule lower portion.

The support shoulder of the capsule closure device typically has a peripheral inner edge. In such a case, the at least one ventilation groove advantageously forms an interruption of this inner edge. Accordingly, the interruption of the inner edge is located precisely at the position at which the capsule upper portion and the capsule lower portion overlap each other in the closed state. If the capsule lower portion is pulled out of the capsule upper portion, the pressure compensation in the inner space can already be carried out at the earliest possible time when the capsule lower portion and the capsule upper portion no longer overlap each other. When the capsule is closed, the pressure compensation can be carried out over the longest possible period of time until the capsule lower portion and capsule upper portion overlap each other again and delimit an air-tight closed inner space per se.

The capsule closure device preferably includes a suction device in order to extract dust particles on the capsule. The suction device can preferably be connected to the ventilation groove. The capsule can thereby be promptly cleaned of dust particles which, for example, have been deposited on the capsule during the filling operation with filling material or which have become disturbed during the closure operation. Provision is preferably made for the support shoulder to be formed by an annular groove in the receiving hole, the annular groove being intended to receive undesired filling material. Preferably, the receiving hole includes a second longitudinal section which adjoins the annular groove and a first longitudinal section which adjoins the second longitudinal section. The first longitudinal section of the receiving hole preferably forms a narrowing for clamping of the capsule upper portion. The capsule which is pushed into the receiving hole is retained in a clamped manner at the capsule upper portion as a result of the narrowing of the second section. The narrowing is configured in such a way that the clamping forces are sufficiently high to prevent capsule jump of the capsule upper portion during the separating and closing operations of the capsule, and desired ejection of the capsule, without the latter being damaged in the process, is nevertheless possible.

Provision is advantageously made for the receiving hole to have a clamping diameter at the narrowing, wherein the clamping diameter is smaller than a basic diameter of the second longitudinal section. The narrowing of the receiving hole is formed by this clamping diameter which is smaller than the basic diameter. Preferably, the basic diameter is constant over the entire second longitudinal section. Advantageously, the clamping diameter is greater than the diameter of the receiving hole at the support shoulder. As a result, the clamping diameter at the narrowing is sufficiently small to hold the capsule upper portion in a clamped manner. The clamping diameter is also still sufficiently large that compression which is of such a magnitude that the capsule upper portion slips past the support shoulder into the introduction hole can be avoided. In an analogous manner, it is also possible for the corresponding capsule lower portion socket to have a narrowing with a combination of basic diameter and clamping diameter. Expediently, the ratio of the clamping diameter to the basic diameter at the capsule upper portion socket is about 0.97, and at the capsule lower portion socket about 0.96.

An independent and likewise inventive concept is to provide the aforementioned capsule closure device merely with the aforementioned narrowing instead of a ventilation groove.

### BRIEF DESCRIPTION OF THE DRAWINGS

The invention will now be described with reference to the drawings wherein:

FIG. 1 is a schematic, partially sectioned side view of a two-piece capsule;

FIG. 2 is a longitudinally sectioned illustration of a capsule closure device according to the disclosure;

FIG. 3 is a sectioned illustration of the capsule upper portion receiving member;

FIG. 4 is a plan view of the capsule upper portion receiving member;

FIG. 5 is a sectioned illustration of the capsule upper portion receiving member with a narrowing; and,

FIG. 6 is a sectioned illustration of the capsule upper portion receiving member with a narrowing, without a ventilation groove.

### DESCRIPTION OF THE PREFERRED EMBODIMENTS OF THE INVENTION

FIG. 1 is a schematic, partially sectioned illustration of a two-piece capsule 20, as used, for example, in the pharmaceutical sector or in the field of food supplements and which in the filled state contains an active ingredient preparation. In the ready filled and closed state, it is provided to be swallowed by a person. Various materials, such as hard gelatin, HPMC or the like, may be considered as the capsule material which dissolves after swallowing and releases the capsule contents.

The two-piece capsule 20 is composed of a capsule upper portion 21 and a capsule lower portion 22, wherein the capsule lower portion 22 is inserted with a lower portion nominal diameter dU into the open side of the capsule upper portion 21 with a larger upper portion nominal diameter DO. The capsule upper portion 21 includes as a conventional construction type a hemispherical cap portion 23 which a cylinder portion 24 adjoins.

At the open side thereof, the capsule upper portion 21 is delimited by a peripheral capsule edge 25 of the cylinder portion 24. The capsule lower portion 22 is constructed in a similar manner to the capsule upper portion 21 and includes a hemispherical cap portion 26 which a cylinder portion 27 adjoins.

At the side facing the capsule upper portion 21 and introduced at that location, the capsule lower portion 22 is delimited with a peripheral capsule edge 28 of the cylinder portion 27, wherein in the assembled state of the capsule upper portion 21 and capsule lower portion 22 a portion of the cylinder portion 27 together with the peripheral capsule edge 28 thereof comes to rest inside the cylinder portion 24 of the capsule upper portion 21.

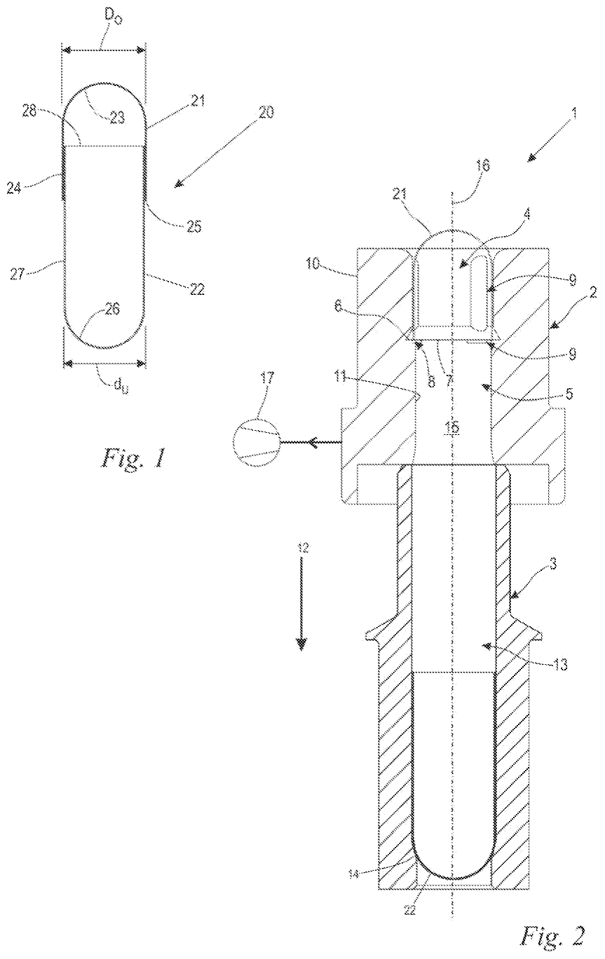

FIG. 2 is a longitudinally sectioned illustration of a capsule closure device 1 according to the disclosure which includes a capsule upper portion receiving member 2 and a capsule lower portion receiving member 3. A capsule closure arrangement having a capsule upper portion 21 and a capsule lower portion 22 of a capsule 20 is arranged in the capsule closure device 1.

Empty capsules 20 according to FIG. 1 are delivered in a state in which the capsule lower portions 22 are loosely inserted into associated capsule upper portions 21 in each case. In this state, a single capsule 20 is introduced into the capsule closure device according to FIG. 2 from above in accordance with an arrow 12 in such a manner that it comes to rest inside the capsule upper portion receiving member 2.

The capsule upper portion receiving member 2 has a receiving hole 4 for receiving the capsule upper portion 21 and merges in the direction toward the capsule lower portion receiving member 3 into a coaxially arranged introduction hole 5. The introduction hole 5 is reduced in terms of its diameter with respect to the diameter of the receiving hole 4 so that at the transition from the receiving hole 4 to the introduction hole 5 a peripheral support shoulder 6 is formed. The support shoulder 6 delimits the receiving hole 4 in a downward direction and is also in the same manner as the introduction hole 5 narrowed with respect to the receiving hole 4. The capsule 20 is introduced in accordance with the arrow 12 into the capsule upper portion receiving member 2 in such a manner that the capsule upper portion 21 comes to rest with the cylinder portion 24 thereof in the receiving hole 5, whilst the peripheral capsule edge 25 of the capsule upper portion 21 rests on the support shoulder 6. The support shoulder 6 has an inner diameter which is reduced with respect to the receiving hole 4 and through which the capsule lower portion 22 can be guided.

Below the capsule upper portion receiving member 2, the capsule lower portion receiving member 3 is positioned coaxially and includes a receiving hole 13. For example, by means of reduced pressure or the like, the capsule lower portion 22 which protrudes into the introduction hole 5 is pulled out of the capsule upper portion 21 into the receiving hole 13 of the capsule lower portion receiving member 3 in the direction of the arrow 12 until it comes to rest with the downwardly facing cap portion 26 thereof on a shoulder 14 which is reduced in terms of diameter with respect to the receiving hole 13. In this instance, the cylinder portion 27 of the capsule lower portion 22 is supported by the peripheral wall of the receiving hole 14.

The capsule lower portion 22 is filled with the active ingredient preparation which is not illustrated, whilst it is retained in the capsule lower portion receiving member 3. After completed filling, the capsule 20 is closed by means of the capsule closure device 1 by the capsule lower portion 21 being pressed, for example, by means of a stamp which is not illustrated counter to the direction of the arrow 12 upward through the receiving hole 14 and the introduction hole 5 into the capsule upper portion 21. In this instance, a counter-force is applied to the capsule upper portion 21 for spatial fixing thereof in the direction of the arrow 12, for example, by means of a stamp which is also not illustrated. During the closure operation, the peripheral capsule edge 28 of the capsule lower portion 22 slides radially at the inner side of the peripheral capsule edge 25 of the capsule upper portion 21 into the cylinder portion 24 thereof.

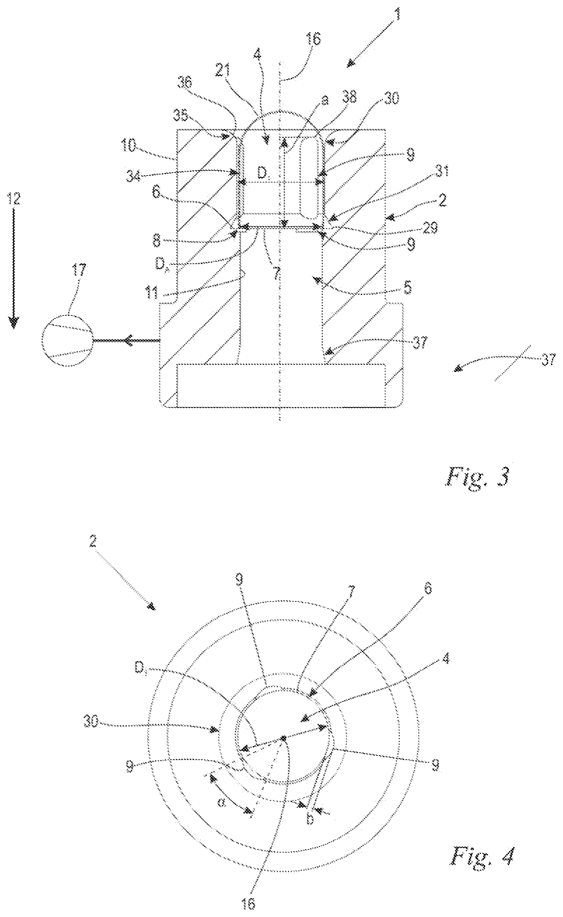

FIG. 3 is an enlarged sectioned illustration of the capsule upper portion receiving member 2 according to FIG. 2. The receiving hole 4 extends along a longitudinal axis 16 of the capsule upper portion receiving member 2 from a first longitudinal end 30 as far as a second longitudinal end 31. The receiving hole 4 can be subdivided, in the direction of the arrow 12, into a plurality of sections in a corresponding sequence, namely the first longitudinal end 30, a longitudinal section 32 and the second longitudinal end 31. The first longitudinal end 30 of the receiving hole 4 is formed by an introduction region 35 with a lead-in chamfer 36 for introduction of the capsule 20. The introduction region 35 tapers in the direction of the arrow 12 and merges into the longitudinal section 34. The longitudinal section 34 extends as far as the second end 31 of the receiving hole 4, wherein the receiving hole 4 is constructed in a cylindrical manner along the longitudinal section 34 and has a constant diameter D₁. The second end 31 is formed by a peripheral annular groove 29 on the inner side 11 of the capsule upper portion receiving member 2. The annular groove 29 serves to receive filling material which has been discharged in an undesirable manner. A support shoulder 6 is configured at the annular groove 29, wherein the support shoulder 6 has a shoulder diameter D_{A} which is smaller than the diameter D₁ of the receiving hole 4 at the longitudinal section 34. When the capsule is introduced into the receiving hole 4, the capsule upper portion 21 comes to rest with its capsule edge 25 on the support shoulder 6. The annular groove 29 prevents the capsule edge 25 of the capsule upper portion 21 from being pressed radially inward by the aforementioned filling material which has accumulated on the support shoulder 6. Formed adjacent to the support shoulder 6 is the introduction hole 5, which extends in the direction of the longitudinal axis 16 of the capsule upper portion receiving member 2 as far as the hole end 37. At the hole end 37, the introduction hole 5 widens in a funnel-like manner in the direction of the arrow 12 again, whereby the introduction of the capsule lower portion 22 after the filling operation into the introduction hole 5 is promoted. As shown in FIGS. 2 to 4, a plurality of ventilation grooves 9 are formed in the capsule upper portion receiving member 2. The preferred embodiment of the capsule upper portion receiving member 2 has three ventilation grooves 9 (FIG. 4). However, the construction of a single ventilation groove 9 may already be advantageous.

When the capsule 20 is separated, the capsule upper portion 21 is in abutment with the capsule edge 25 thereof flush with the inner side 11 of the receiving hole 4. If the capsule lower portion 22 is pulled out of the capsule upper portion 21, the capsule edge 28 of the capsule lower portion 22 is also in abutment flush with the inner side 11 of the introduction hole 5. In this instance, the capsule upper portion 21 and capsule lower portion 22 delimit an inner space 15. Through the ventilation groove 9, an air exchange between the inner space 15 and the environment outside the capsule upper portion receiving member 2 is enabled. Consequently, during separation and closure of the capsule 20, a pressure compensation takes place so that a reduced pressure or excess pressure which is applied in the inner space 15 can be prevented.

The ventilation groove 9 is formed on the inner side 11 of the capsule upper portion receiving member 2. As shown in FIG. 3, the ventilation groove 9 extends from the introduction hole 5 to the receiving hole 4. In the embodiment, the ventilation groove 9 extends from the introduction hole 5 to the first longitudinal end 30 of the receiving hole 4. Accordingly, the ventilation groove 9 extends as far as the introduction region 35 of the receiving hole 4. Since the introduction region 35 has the lead-in chamfer 36, the capsule upper portion 21 does not abut the inner side 11 in the introduction region 35. The ventilation groove 9 is thus not closed by the capsule 20 in the introduction region 35, whereby a pressure compensation with the environment can take place. In an alternative embodiment of the capsule closure device 1, for effective pressure compensation it may even be sufficient for the ventilation groove 9 to extend merely into the longitudinal section 34. This holds true if the longitudinal section 34 of the receiving hole 4 extends over a particularly wide longitudinal region in the direction of the longitudinal axis 16. The ventilation groove 9 should then extend into the receiving hole 4 at least to such an extent that that end 38 of the ventilation groove 9 which faces away from the support shoulder 6 has a spacing a from the support shoulder 6 that corresponds at least to the diameter D₁ of the receiving hole 4 at the longitudinal section 34.

As shown in FIG. 3, in the preferred embodiment the ventilation groove 9 extends through the support shoulder 6 and thereby forms an interruption 8 of the substantially peripheral inner edge 7 of the support shoulder 6. With the interruption 8 of the inner edge 7 of the support shoulder 6, the capsule edge 25 of the capsule upper portion 21 does not abut the support shoulder 6 in an air-tight manner, whereby the earliest possible pressure compensation is ensured.

FIG. 4 is a plan view of the capsule upper portion receiving member 2 according to the embodiment of FIG. 2. The ventilation grooves 9 are distributed in a peripheral direction of the longitudinal axis 16 with a uniform angular spacing. Accordingly, in the embodiment according to FIG. 4, the angular spacing of the three ventilation grooves 9 is 120°. It may also be advantageous to construct the ventilation grooves 9 in the capsule upper portion receiving member 2 with a non-uniform angular spacing in the peripheral direction of the longitudinal axis 16.

As shown in FIG. 4, the ventilation groove 9 extends in the peripheral direction of the longitudinal axis 16 over a width which corresponds to an angular spacing a of at least 15°, preferably at least 30°, advantageously approximately over 40°. The ventilation groove 9 has a depth b, measured radially with respect to the longitudinal axis 16, which corresponds to a range of between 2 and 10% of the diameter D₁ of the receiving hole 4 at the longitudinal section 34. In the embodiment, the depth b of the ventilation groove 9 is approximately 6% of the diameter D₁. The ventilation grooves 9 are preferably of identical construction. The ventilation grooves 9 can be produced, for example, by drilling, milling or erosion.

FIG. 5 shows a further embodiment variant of the capsule closure device 1 which differs from the embodiment according to FIG. 3 merely in that there is an additional narrowing 40 for clamping of the capsule upper portion 21 in the receiving hole 4. That longitudinal section 34 of the receiving hole 4 which is shown in the preceding embodiment is subdivided into a first longitudinal section 32 and a second longitudinal section 33 adjacent thereto. The first longitudinal section 32 thus extends from the first longitudinal end 30 as far as the second longitudinal section 33, wherein the second longitudinal section 33 is adjacent to the second longitudinal end 31.

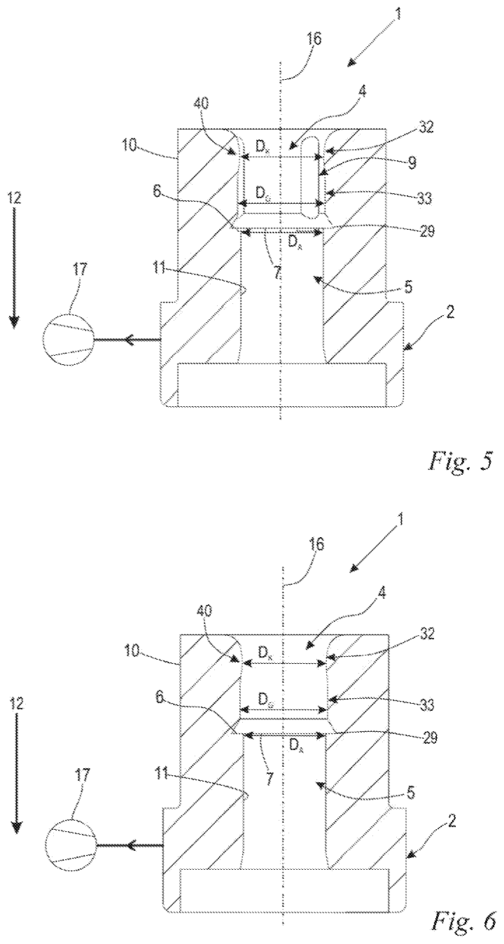

As shown in FIG. 5, the receiving hole 4 includes a narrowing 40 for clamping of the capsule upper portion 21. The narrowing 40 is formed in the first longitudinal section 32 of the receiving hole 4. The narrowing 40 is formed by a reduction in the cross section of the receiving hole 4. The first longitudinal section 32 has a clamping diameter D_{K} which is smaller than a basic diameter D_{G} of the second longitudinal section 33. The clamping diameter D_{K} corresponds to the smallest diameter in the first longitudinal section 32. The receiving hole 4 is constructed in a cylindrical manner in the second longitudinal section 33. The basic diameter D_{G} of the second longitudinal section 33 is therefore constant. In an alternative embodiment, it may be advantageous to construct the second longitudinal section in a non-cylindrical manner. In such a case, the clamping diameter D_{K} of the first longitudinal section 32 is smaller than each diameter in the second longitudinal section 33. The clamping diameter D_{K} at the narrowing 40 is smaller than the external diameter of the capsule upper portion 21, such that the capsule upper portion 21 is clamped by the narrowing 40. As shown in the embodiment, it is advantageous for the narrowing 40 to be formed close to the first longitudinal end 30 of the receiving hole 4, since compression of the capsule edge 25 of the capsule upper portion 21 is avoided. This is necessary in order to ensure process-reliable support of the capsule upper portion 21 on the support shoulder 6 and to secure the capsule upper portion 21 against sliding through into the introduction hole 5. The narrowing 40 therefore lies on the upper longitudinal half, that is, that longitudinal half of the receiving hole 4 which faces away from the support shoulder 6. In the preferred embodiment, the clamping diameter D_{K} is greater than the diameter D_{A} of the receiving hole 4 at the support shoulder 6. FIG. 6 shows a further embodiment in which merely a narrowing 40 is formed, without a ventilation groove 9.

In a development, the capsule closure device 1 according to the disclosure may include a suction device 17 which is indicated only schematically in FIG. 2. The suction device 17 is connected to the one or the plurality of ventilation groove(s) 9 and serves primarily to extract dust particles which are adhering to the capsule 20. In order to clean the capsule 20, the suction device 17 is only switched on when the capsule 20 is already closed again after the filling operation. The capsule content is thereby prevented from being extracted by the suction device 17 from the capsule lower portion 3. In addition, the suction device 17 can also be used to clean the capsule upper portion receiving member 2 in terms of dust particles which are deposited, for example, on the inner side 11 of the capsule upper portion receiving member 2.

It is understood that the foregoing description is that of the preferred embodiments of the invention and that various changes and modifications may be made thereto without departing from the spirit and scope of the invention as defined in the appended claims.

What is claimed is:

1. A capsule closure device for closing two-piece capsules each having a capsule upper portion and a capsule lower portion, the capsule closure device comprising:
a capsule upper portion receiving member and a capsule lower portion receiving member;
said capsule upper portion receiving member defining a receiving hole and an introduction hole which is arranged coaxially relative to said receiving hole;
said capsule upper portion receiving member having an inner side;
said capsule upper portion receiving member having a support shoulder for supporting said capsule upper portion at said inner side, wherein said support shoulder is disposed between said receiving hole and said introduction hole; and,
said capsule upper portion receiving member defining at said inner side at least one ventilation groove, wherein said ventilation groove extends from said receiving hole to said introduction hole.

2. The capsule closure device of claim 1, wherein said capsule upper portion receiving member defines at least two ventilation grooves at said inner side.

3. The capsule closure device of claim 1, wherein said capsule upper portion receiving member defines three ventilation grooves at said inner side.

4. The capsule closure device of claim 1, wherein said receiving hole extends from a first longitudinal end as far as a second longitudinal end at said support shoulder, wherein said at least one ventilation groove extends as far as said first longitudinal end of said receiving hole.

5. The capsule closure device of claim 1, wherein said support shoulder has a peripheral inner edge; and, said at least one ventilation groove forms an interruption of said inner edge.

6. The capsule closure device of claim 1 further comprising a suction device configured to extract dust particles on the capsule.

7. The capsule closure device of claim 1, wherein said support shoulder is formed by an annular groove in said receiving hole, said annular groove being configured to receive undesired filling material.

8. The capsule closure device of claim 7, wherein said receiving hole includes a second longitudinal section which is adjacent to said annular groove and a first longitudinal section which is adjacent to said second longitudinal section; and, wherein said first longitudinal section of said receiving hole forms a narrowing for clamping of the capsule upper portion.

9. The capsule closure device of claim 8, wherein said receiving hole has a clamping diameter (D_{K}) at said narrowing; and, wherein said clamping diameter (D_{K}) is smaller than a basic diameter (D_{G}) of said second longitudinal section.

10. The capsule closure device of claim 9, wherein the basic diameter (D_{G}) is constant over an entirety of said second longitudinal section.

11. The capsule closure device of claim 9, wherein said receiving hole defines a clamping diameter (D_{A}) at said support shoulder; and, said clamping diameter (D_{K}) is greater than said clamping diameter (D_{A}).
